(19) United States
(12) Patent Application Publication
(10) Pub. No.: US 2014/0131212 A1
(43) Pub. Date: May 15, 2014

(54) ELECTRODEPOSITABLE COATING COMPOSITIONS CONTAINING DIMETHYL CATALYST

(71) Applicant: PPG INDUSTRIES OHIO, INC., Cleveland, OH (US)

(72) Inventors: Lorraine Hsu, Pittsburg, PA (US); Kelly Moore, Dunbar, PA (US); Michael Sandala, Pittsburgh, PA (US); Craig Wilson, Allison Park, PA (US)

(73) Assignee: PPG INDUSTRIES OHIO, INC., Cleveland, OH (US)

(21) Appl. No.: 13/778,716

(22) Filed: Feb. 27, 2013

Related U.S. Application Data
(60) Provisional application No. 61/725,126, filed on Nov. 12, 2012.

(51) Int. Cl. C25D 9/02; C09D 163/00

(52) U.S. Cl. CPC C25D 9/02; C09D 163/00
USPC 205/317

(57) ABSTRACT

An electrodepositable composition comprising;
(a) an active hydrogen-containing, cationic salt group-containing resin, such as a (meth)acrylic sulfonium salt group-containing resin;
(b) a capped polyisocyanate curing agent; and
(c) a dimethyltin dicarboxylate or dimercaptide, such as dimethyltin dicarboxylate or dimercaptide in which the carboxylate and mercaptide groups contain from 8 to 12 carbon atoms.

### FIELD OF THE INVENTION

The present invention relates to cationic electrodepositable compositions and to their use in electrodeposition.

### BACKGROUND OF THE INVENTION

The application of a coating by electrodeposition involves depositing a film-forming composition to an electrically conductive substrate under the influence of an applied electrical potential. Electrodeposition has gained prominence in the coatings industry because in comparison with non-electrophoretic coating methods, electrodeposition provides higher paint utilization, outstanding corrosion resistance, and low environmental contamination. Early attempts at commercial electrodeposition processes used anionic electrodeposition where the workpiece being coated served as the anode. However, in 1972, cationic electrodeposition was introduced commercially. Since that time, cationic electrodeposition has become increasingly popular and today is the most prevalent method of electrodeposition. Throughout the world, more than 80 percent of all motor vehicles manufactured are given a primer coating by cationic electrodeposition.

Many cationic electrodeposition compositions used today are based on active hydrogen-containing resins derived from a polyepoxide and a capped polyisocyanate curing agent. These cationic electrodeposition compositions conventionally contain solid organotin catalysts such as dibutyltin oxide to activate cure of the electrodeposition composition. Many of these organotin catalysts are solids at room temperature, they can be difficult to incorporate into the electrodeposition composition, requiring milling with a dispersing vehicle to form a paste which is added to the electrodeposition composition. The milling operation requires additional time, labor and equipment, and adds to the cost of preparing the electrodeposition composition. One alternative to milling is to incorporate a liquid tin catalyst, such as dibutyltin diacetate, in the electrodeposition coating. Electrodeposition compositions containing these types of catalysts are often not storage stable and over time they tend to hydrolyze and result in precipitation of solid tin compounds.

It would be desirable to provide an electrodepositable composition which demonstrates enhanced storage stability without loss of cured film properties or appearance and which contains catalysts that complement such enhanced storage stability and that do not have the shortcomings of those of the prior art.

### SUMMARY OF THE INVENTION

In one aspect of the present invention, an electrodepositable composition is provided comprising:
(a) an active hydrogen-containing, cationic salt group-containing resin electrodepositable on a cathode;
(b) a capped polyisocyanate curing agent; and
(c) a dimethyltin dicarboxylate or dimercaptide; wherein at least one of the carboxylates and usually both, and at least one and usually both of the mercaptides contains from 8 to 12 carbon atoms.

In another aspect of the present invention, an electrodepositable composition is provided comprising:
(a) a cationic (meth)acrylic resin such as a (meth)acrylic resin containing sulfonium salt groups;
(b) a capped polyisocyanate curing agent; and
(c) a dimethyltin dicarboxylate or dimercaptide.

### DETAILED DESCRIPTION

The cationic resins include those known to those skilled in the art. The cationic resins are preferred for electrodeposition onto the substrate as a cathode because these resins usually provide superior corrosion resistance. Typically the cationic resins are derived from a polyepoxide. The resin contains cationic salt groups and active hydrogen groups such as those selected from aliphatic hydroxyl and primary and secondary amino. Such cationic resins can be as those described in U.S. Pat. Nos. 3,663389; 3,922,253; 3,984,299; 3,947,339; 3,947,388; and 4,031,050.

The polyepoxide has an epoxy equivalency greater than 1. In general, the epoxide equivalent weight of the polyepoxide will range from 100 to about 2000, typically from about 180 to 500. The polyepoxide may be saturated or unsaturated, cyclic or acyclic, aliphatic, alicyclic, aromatic or heterocyclic.

Examples of polyepoxides are epoxy group-containing polymers having a 1,2-epoxy equivalency greater than one and preferably at least two; that is, polyepoxides which have on average two or more epoxide groups per molecule. The preferred polyepoxides are polyglycidyl ethers of cyclic polyols, Particularly preferred are polyglycidyl ethers of polyhydric phenols such as Bisphenol A. These polyepoxides can be produced by etherification of polyhydric phenols with an epihalohydrin or dihalohydrin such as epichlorohydrin or dichlorohydrin in the presence of alkali. Besides polyhydric phenols, other cyclic polyols can be used in preparing the polyglycidyl ethers of cyclic polyols. Examples of other cyclic polyols include alicyclic polyols, particularly cycloaliphatic polyols such as 1,2-cyclohexane did and 1,2-bis(hydroxymethyl)cyclohexane.

Besides the polyglycidyl ethers of polyhydric phenols, epoxy-containing (meth)acrylic polymers may be used as the polyepoxide.

Suitable (meth)acrylic polymers can include copolymers of one or more alkyl esters of (meth)acrylic acid optionally together with one or more other polymerizable ethylenically unsaturated monomers. Suitable alkyl esters of (meth)acrylic acid include methyl (meth)acrylate, ethyl (meth)acrylate, butyl (meth)acrylate, isobornyl (meth)acrylate and 2-ethyl hexyl (meth)acrylate. Suitable other copolymerizable ethylenically unsaturated monomers include nitriles such as (meth)acrylonitrile, vinyl and vinylidene halides such as vinyl chloride and vinylidene fluoride and vinyl esters such as vinyl acetate. Acid and anhydride functional ethylenically unsaturated monomers such as (meth)acrylic acid or anhydride, itaconic acid, maleic acid or anhydride, or fumaric acid may be used. Amide functional monomers including (meth)acrylamide and N-alkyl substituted (meth)acrylamides are also suitable. Vinyl aromatic compounds such as styrene, α-methylstyrene and vinyl toluene can also be used so long as photodegradation resistance of the polymer and the resulting electrodeposited coating is not compromised. It will be understood that “(meth)acrylic” and like terms refers to both methacrylic and acrylic, as is standard in the art. Epoxide functional groups (for conversion to cationic salt groups) may be incorporated into the acrylic polymer by using functional monomers such as glycidyl (meth)acrylate, 3,4-epoxycyclohexyl-methyl(meth)acrylate, epoxycyclohexyl)ethyl(meth)acrylate, and/or allyl glycidyl ether. Alternatively, epoxide functional groups may be incorporated into the acrylic polymer by reacting carboxyl groups on the acrylic polymer with an epihalohydrin or dihalohydrin such as epichlorohydrin or dichlorohydrin.

The (meth)acrylic polymer can be prepared by traditional free radical initiated polymerization techniques, such as solution or emulsion polymerization, as known in the art, using suitable catalysts including organic peroxides and azo-type compounds and optionally chain transfer agents such as alpha-methyl styrene dimer and tertiary dodecyl mercaptan. Additional acrylic polymers that are suitable for forming the cationic resin used in the electrodepositable compositions of the present invention include those resins described in U.S. Pat. Nos. 3,455,806, 3,928,157 and U.S. Publication No. 2003/0054193.

Cationic salt groups can be introduced by the reaction of an epoxy group-containing polymer of the types described above with appropriate salt forming compounds. For example, sulfonium salt groups can be introduced by reacting a sulfide in the presence of an acid, as described in U.S. Pat. Nos. 3,959,106 and 4,715,898; amine salt groups can be derived from the reaction of an epoxide functional acrylic polymer with a compound containing a primary or secondary amine group, such as methylamine, diethanolamine, ammonia, diisopropanolamine, N-methyl ethanolamine, diethylenetriamine, dipropylenetriamine, bishexamethylenetriamine, the diketimine of diethylenetriamine, the diketimine of dipropylenetriamine, the diketimine of bishexamethylenetriamine and mixtures thereof. The amine groups can be at least partially neutralized with an acid. Suitable acids include organic and inorganic acids such as formic acid, acetic acid, lactic acid, phosphoric acid, dimethylolpropionic acid and sulfamic acid. Mixtures of acids can be used. The resin can contain primary, secondary and/or tertiary amino groups. For (meth)acrylic polymers, amine salt groups can be introduced directly by using an amino group-containing monomer such as an aminoalkyl (meth)acrylate, for example dimethylaminopropyl methacrylate.

The extent of cationic salt group formation should be such that when the resin is mixed with an aqueous medium and the other ingredients, a stable dispersion of the electrodepositable composition will form. By “stable dispersion” is meant one that does not settle or is easily redispersible if some settling occurs. Moreover, the dispersion should be of sufficient cationic character that the dispersed particles will migrate toward and electrodeposit on a cathode when an electrical potential is set up between an anode and a cathode immersed in the aqueous dispersion.

Generally, the cationic resin contains from about 0.1 to 3.0, preferably from about 0.1 to 0.7 milliequivalents of cationic salt group per gram of resin solids. The weight average molecular weight of the cationic resin preferably ranges from about 5,000 to 100,000, For the cationic resins derived from polyglycidyl ethers of polyphenols, weight average molecular weights of about 5,000 to about 60,000, such as about 10,000 to about 40,000 are typical. For cationic resins derived from (meth)acrylic polymers, weight average molecular weights of about 5,000 to 100,000, such as about 10,000 to 50,000 are typical.

The cationic resins contain active hydrogen groups that are present before and/or after cationic salt group formation. The active hydrogens include any active hydrogens that are reactive with isocyanates within the temperature range of about 93° C. to 232° C., preferably about 121° C., to 206° C., as are known to those skilled in the art. Most often, the active hydrogens are selected from the group consisting of hydroxyl and primary and secondary amino, including mixed groups such as hydroxyl and primary amino. Preferably, the active hydrogen-containing cationic resin will have an active hydrogen content of about 1.7 to 10 milliequivalents, more preferably about 2.0 to 5 milliequivalents of active hydrogen per gram of resin solids.

Typically, the active hydrogen-containing cationic resin as Component A is present in the electrodepositable composition in amounts of about 50 to 75, preferably about 55 to 70 percent by weight based on weight of main vehicle resin solids. By “main vehicle resin solids” is meant resin solids attributable to the active hydrogen-containing, cationic salt group-containing resin of Component A and the polyisocyanate curing agent of Component B so that the total amounts of these components equals 100 percent by weight.

The electrodepositable composition of the present invention also contains a capped polyisocyanate curing agent. The polyisocyanate curing agent may be a fully capped polyisocyanate with substantially no free isocyanate groups, or it may be partially capped and reacted with the resin backbone as described in U.S. Pat. Nos. 3,984,299 and 5,366,529. The polyisocyanate can be an aliphatic or an aromatic polyisocyanate or a mixture of the two. Diisocyanates are preferred, although higher polyisocyanates can be used in place of or in combination with diisocyanates.

Examples of suitable aliphatic diiscoyanates are straight chain aliphatic diisocyanates such as 1,4-tetramethylene diisocyanate and 1,6-hexamethylene diisocyanate. Also, cycloaliphatic diisocyanates can be employed. Examples include isophorone diisocyanate and 4,4′-methylene-bis-(cyclohexyl isocyanate), Examples of suitable aromatic diisocyanates are p-phenylene diisocyanate, diphenylmethane-4,4′-diisocyanate and 2,4 or 2,6-toluene diisocyanate. Suitable higher polyisocyanates are triphenylmethane-4,4′,4″-triisocyanate, 1,2,4-benzene triisocyanate and poly ethylene polyphenyl isocyanate,

Any suitable aliphatic, cycloaliphatic, or aromatic alkyl monoalcohol or phenolic compound may be used as a capping agent for the capped polyisocyanate curing agent in the composition of the present invention including, for example, lower aliphatic alcohols such as methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Diethylene glycol butyl ether is preferred among the glycol ethers.

Other suitable capping agents include oximes such as methyl ethyl ketoxime, acetone oxime and cyclohexanone oxime, lactams such as epsilon-caprolactam, and amines such as dibutyl amine.

The capped polyisocyanate curing agent is typically present in the electrodepositable composition in amounts of about 26 to 50, preferably about 30 to 45 percent by weight based on weight of resin solids, Typically, there is sufficient polyisocyanate present in the composition of the present invention to provide about 0.1 to about 1.2, usually 0.5 to 1, such as about 1 to 1 capped isocyanate groups for each active hydrogen in the cationic resin of Component A.

The dimethyltin compound can be dimethyltin dicarboxylate or dimethyltin dimercaptide. For the dimethyltin dicarboxylate, at least one and usually both of the carboxylate groups will have from 8 to 12, such as 9 to 12 carbon atoms. Examples of such compounds are dimethyltin dineodeconate and dimethyltin dilaurate. For the dimethyltin dimercaptide, at least one and usually both of the mercaptide groups will contain from 8 to 12 carbon atoms. Examples include dimethyltin di(2-ethylhexyl mercaptoacetate) and dimethyltin di(isooctyl mercaptoacetate).

Examples of other dimethyltin compounds include dimethyltin diacetate.

The diorganotin dicarboxylate may be incorporated into the electrodepositable composition in several ways. It may be added to the final reaction mixture of the main vehicle, i.e., the active hydrogen-containing resin, just before solubilization with water and acid as described above. Alternatively, it may be added to a partially solubilized resin kept at high enough solids so as to be sheared into the final composition. Additionally, it may be co-dispersed with polyepoxide-polyoxyalkylene-polyamine modifying anti-crater resins such as those described in U.S. Pat. No. 4,423,166. It may also be added as a component of a pigment paste via addition to a conventional pigment grinding vehicle such as those disclosed in U.S. Pat. No. 4,007,154.

Unlike convention& organotin catalysts such as dibutyltin oxide and organotin catalysts of the prior art such as dibutyltin diacetate and dibutyltin dilaurate, the dimethyltin catalysts used in the electrodepositable compositions of the present invention do not cause precipitation of solids such as dibutyltin oxide from the composition over time. The compositions of the present invention are heat stable and storage stable.

The diorganotin dicarboxylate of component (c) is present in the electrodepositable composition of the present invention in amounts of at least about 0.01 percent by weight tin based on the weight of the total solids of electrodepositable composition, usually about 0.01 to 1.5 percent tin by weight, and more usually about 0.1 to 0.5 percent tin by weight.

The composition of the present invention is preferably used in an electrodeposition process in the form of an aqueous dispersion. By “dispersion” is meant a Iwo-phase transparent, translucent, or opaque aqueous resinous system in which the resin, curing agent, pigment, and water-insoluble materials are the dispersed phase and water and water-soluble materials comprise the continuous phase. The dispersed phase has an average particle size less than about 10 microns, preferably less than 5 microns. The aqueous dispersion preferably contains at least about 0.05 and usually about 0.05 to 50 percent by weight resin solids, depending on the particular end use of the dispersion.

The aqueous dispersion may optionally contain a coalescing solvent such as hydrocarbons, alcohols, esters, ethers and ketones. Examples of preferred coalescing solvents are alcohols, including polyols, such as isopropanol, butanol, 2-ethylhexanol, ethylene glycol and propylene glycol; ethers such as the monobutyl and monohexyl ethers of ethylene glycol; and ketones such as 4-methyl-2-pentanone (MIBK) and isophorone. The coalescing solvent is usually present in an amount up to about 40 percent by weight, preferably ranging from about 0.05 to 25 percent by weight based on total weight of the aqueous medium.

The electrodepositable composition of the present invention may further contain pigments and various other optional additives such as plasticizers, surfactants, wetting agents, defoamers, and anti-cratering agents.

Examples of suitable surfactants and wetting agents include alkyl imidazolines such as those available from Geigy Industrial Chemicals as GEIGY AMINE C, and acetylenic alcohols available from Air Products and Chemicals as SURFYNOL 104. Examples of defoamers include a hydrocarbon containing inert diatomaceous earth available from Crucible Materials Corp. as FOAMKILL 63. Examples of anti-cratering agents are polyoxyalkylene-polyamine reaction products such as those described in U.S. Pat. No. 4,432,850. These optional ingredients, when present, are usually used in an amount up to 30 percent by weight, typically about 1 to 20 percent by weight based on weight of resin solids.

Suitable pigments include, for example, iron oxides, carbon black, coal dust, titanium dioxide, talc, clay, and barium sulfate. Lead pigments may also be used. The pigment content of the aqueous dispersion, generally expressed as the pigment to resin (or binder) ratio (PIS) is usually about 0.01:1 to 1:1.

In the process of electrodeposition, the aqueous dispersion is placed in contact with an electrically conductive anode and cathode. Upon passage of an electric current between the anode and cathode while they are in contact with the aqueous dispersion, an adherent film of the electrodepositable composition will deposit in a substantially continuous manner on the cathode. Electrodeposition is usually carried out at a constant voltage in the range of from about 1 volt to several thousand volts, typically between 50 and 500 volts. Current density is usually between about 1.0 ampere and 15 amperes per square foot (10.8 to 161.6 amperes per square meter) and tends to decrease quickly during the electrodeposition process, indicating formation of a continuous self-insulating film. Any electro-conductive substrate, especially metal substrates such as steel, zinc, aluminum, copper, magnesium or the like can be coated with the electrodepositable composition of the present invention. Steel substrates are preferred because the composition provides significant corrosion protection to these substrates. Although it is conventional to pretreat the steel substrate with a phosphate conversion coating followed by a chromic acid rinse, the composition of the present invention may be applied to steel substrates which have not been given a chrome rinse and still provides excellent corrosion resistance.

After deposition, the coating is heated to cure the deposited composition. The heating or curing operation is usually carried out at a temperature in the range of from 120° C. to 250° C., preferably from 120° C. to 205° C. for a period of time ranging from 10 to 60 minutes. The thickness of the resultant film is usually from about 10 to 50 microns.

The invention will be further described by reference to the following examples. Unless otherwise indicated, all parts are by weight.

### EXAMPLES

### Example A

A series of cationic sulfonium at group-containing electrodeposition resins were prepared from the following mixture of ingredients:

| Charge | Chemical | Weight |
|---|---|---|
| 1 | Ethylene glycol monohexyl ether | 27 |
| | Propylene glycol monomethyl ether | 22 |
| | Diethylene glycol monobutyl ether | 19 |
| | Deionized water | 7 |
| 2 | Butyl acrylate | 47 |
| | Hydroxypropyl methacrylate | 16 |
| | 2,2′-azodi(2-methylbutyronitrile) | 0.3 |
| 3 | Butyl acrylate | 169 |
| | Styrene | 75 |
| | Hydroxypropyl methacrylate | 78 |
| | Methyl methacrylate | 172 |
| | Glycidyl methacrylate | 69 |
| | t-Dodecyl mercaptan | 6 |
| 4 | 2,2′-azodi(2-methylbutyronitrile) | 12 |
| | Diethylene glycol monobutyl ether | 19 |
| | Propylene glycol monomethyl ether | 11 |
| | Ethylene glycol monohexyl ether | 30 |
| 5 | t-butyl peroxyacetate | 13 |
| | Diethytene glycol monobutyl ether | 5 |
| | Propylene glycol monomethyl ether | 3 |
| | Ethylene glycol monohexyl ether | 5 |
| 6 | Thiodiethanol | 112 |
| | Lactic acid¹ | 33 |
| | 12-hydroxystearic acid | 14 |
| | Deionized water | 25 |
| 7 | Crosslinker² | 408 |
| | Dimethyltin catalyst | 22 |
| | Ethylene glycol monohexyl ether | 13 |
| | Diethylene glycol monobutyl ether- | 15 |
| | formaldehyde adduct | |
| 8 | Deionized water | 1253 |
| | Sulfonium cationic epoxy grind vehicle | 212 |
| 9 | Deionized water | 757 |

¹Lactic acid concentration at 88% under aqueous conditions.
²Crosslinker - This component is comprised of neo-adduct of isophorone diisocyanate and trimethylol propane (3:1 mole ratio) blocked with ethylene glycol monobutyl ether.

Charge 1 was added to a 4-necked flask fitted with a thermocouple, nitrogen sparge, and a mechanical stirrer. Under an N₂ blanket and agitation, the flask was heated to reflux with a temperature setpoint of 120° C. Charge 2 was added over 30 minutes followed by a 30-minute hold. Charges 3 and 4 were added dropwise from an addition funnel over 150 minutes followed by a 30-minute hold. Charge 5 was subsequently added over 20 minutes followed by a 30-minute hold.

The temperature was decreased to 85° C. Charge 6 was added and held for 3 hours at 85° C. After the hold, charge 7 was added followed by a 20-minute hold. The contents from the reactor were dispersed into charge 8 under rapid agitation, and held for 60 minutes. Charge 9 was added under agitation as the dispersant continued to cool to ambient temperature.

The dispersant yielded a solids percent of 28-30%. GPC analyses to determine weight average molecular weight showed values of 19,286 and was done with DMF using polystyrene standards.

The weight ratio of butyl acrylate/hydroxypropyl methacrylate/methyl methacrylate/glycidyl methacrylate was 38/15/36/11.

### Example B

A cationic sulfonium salt group-containing electrodeposition resin similar to Example A was prepared but which also contained styrene. The butyl acrylate/hydroxypropyl methacrylate/methyl methacrylate/styrene/glycidyl methacrylate weight ratio was 38/15/27.5/8.5/11.5.

### Example C

A cationic sulfonium salt group-containing electrodeposition resin similar to Example B was prepared but in which the butyl acrylate/hydroxypropyl methacrylate/methyl methacrylate/styrene/glycidyl methacrylate weight ratio was 27/15/35/12/11.

### Example D

A cationic sulfonium salt group-containing electrodeposition resin similar to Examples B and C was prepared but in which the butyl acrylate/hydroxypropyl methacrylate/methyl methacrylate/styrene/glycidyl methacrylate weight ratio was 30.5/15/35/8.5/11.

### Example E

A cationic sulfonium salt group-containing electrodeposition resin similar to Example A was prepared but which also contained styrene. The butyl acrylate/hydroxypropyl methacrylate/methyl methacrylate/styrene/glycidyl methacrylate weight ratio was 38/15/35/1/11.

Various diorganotin catalysts were added to the resins of Examples A-D as shown in Table I below. The resins were then subjected to a filterability test.

The test method requires the experimental resin in question to be filtered through a 5-micron Whatman cellulose nitrate filter using a Masterflex pump (Model 77200-62) from Cole Palmer (Setting #3). The filter is attached to PVC tubing, and the pump is used to push the resin through the filter.

All tested resins were diluted to 23.5% total solids. A total of 600 milliliters of each resin was filtered. The time that it takes to filter 600 mL of resin was recorded. If the 600 mL of resin was not filtered within the 5 minutes, the total number of milliliters that was filtered was measured and recorded.

The results are reported in Table I below.

TABLE I

| Cationic Resin | | Milliliters | Time to | |
|---|---|---|---|---|
| Example | Diorganotin Catalyst | Filtered | Filter | |
| A | None | 600 | 77 | sec. |
| A | Dibutyltin dioleate | 134 | 5 | min. |
| E | Dibutyltin diacetate | 163 | 5 | mm. |
| A | Dimethyltin dineodeconate | 600 | 60 | sec. |
| B | Dimethyltin dineodeconate | 600 | 62 | sec. |
| C | Dimethyltin dineodeconate | 600 | 59 | sec. |
| D | Dimethyltin dineodeconate | 600 | 60 | sec. |

The results reported in Table I show that the cationic sulfonium salt group-containing electrodeposition resin containing the dimethyltin dineodeconate catalyst had superior filterability than similar resins containing dibutyltin catalyst.

1. An electrodepositable composition comprising an aqueous dispersion of:
(a) an active hydrogen-containing, cationic salt group-containing resin containing sulfonium salt groups electrodepositable on a cathode;
(b) a capped polyisocyanate curing agent; and
(c) a dimethyltin dicarboxylate; wherein both carboxylate groups contain from 8 to 12 carbon atoms.

2. The electrodepositable composition of claim 1 in which the active hydrogen-containing, cationic salt group-containing resin is derived from an epoxy-containing material.

3. The electrodepositable composition of claim 2 in which the epoxy-containing material is a polyglycidyl ether of a polyhydric alcohol.

4. The electrodepositable composition of claim 2 in which the epoxy-containing material is an epoxy-containing (meth)acrylic polymer.

5. (canceled)

6. The electrodepositable composition of claim 1 in which the dicarboxylate is dineodecanoate.

7. (canceled)

8. The electrodepositable composition of claim 1 in which the active hydrogen-containing, cationic salt group-containing resin is present in amounts of about 50 to 75 percent by weight, based on weight of resin solids.

9. The electrodepositable composition of claim 1 in which the capped polyisocyanate curing agent is present in amounts of about 25 to 50 percent by weight, based on weight of resin solids.

10. The electrodepositable composition of claim 1 in which the dimethyltin dicarboxylate is present in amounts of about 0.01 to 1.5 percent tin by weight, based on weight of total solids of the electrodepositable composition.

11. An electrodepositable coating composition comprising an aqueous dispersion of:
(a) a cationic (meth)acrylic resin containing sulfonium salt groups;
(b) a capped polyisocyanate curing agent; and
(c) a dimethyltin dicarboxylate in which both carboxylate groups contain from 8 to 12 carbon atoms.

12. The coating of claim 11 wherein the cationic (meth)acrylic resin is derived from an epoxy functional (meth)acrylic resin.

13. The coating of claim 11, wherein the dicarboxylate is dineodecanoate.

14. (canceled)

15. The coating of claim 11, wherein the dimethyitin dicarboxylate is present in amounts of about 0.01 to 1.5 percent tin by weight, based on total weight of the electrodepositable composition.

16. The coating of claim 11, wherein said cationic (meth)acrylic resin is present in amounts of about 50 to 75 percent by weight, based on weight of resin solids.

17. The coating of claim 11, wherein the capped polyisocyanate is present in amounts of about 20 to 50 percent by weight, based on weight of resin solids.

18. A method for electrocoating a substrate, comprising electrodepositing the composition of claim 1 on the substrate.

19. A method for electrocoating a substrate, comprising electrodepositing the composition of claim 11 on the substrate.
